(19) United States
(12) Patent Application Publication
(10) Pub. No.: US 2016/0063407 A1
(43) Pub. Date: Mar. 3, 2016

(54) COMPUTING BEHAVIORAL GROUP PERFORMANCE CHARACTERISTICS

(71) Applicant: International Business Machines Corporation, Armonk, NY (US)

(72) Inventors: Peter Bak, Haifa (IL); Gilad M. Saadoun, Haifa (IL); Harold J. Ship, Mitzpe Netofa (IL); Avi Yaeli, Ramot Menashe (IL)

(21) Appl. No.: 14/469,601

(22) Filed: Aug. 27, 2014

(51) Int. Cl. G06Q 10/06

(52) U.S. Cl. CPC G06Q 10/0639

(57) ABSTRACT

Methods, computing systems and computer program products implement embodiments of the present invention that include receiving, by a computer, signals from a multiplicity of independently operated mobile entities, and identifying, based on the received signals, a collaboration between a first given entity and a second given entity. Based on the received signals, a quality of the collaboration can be computed.

### FIELD OF THE INVENTION

The present invention relates generally to performance analysis, and specifically to use location and movement analysis to compute productivity metrics for collaborative tasks.

### BACKGROUND

Measuring productivity of equipment and operators in capital-intensive industries such as mining is extremely important in order to monitor and potentially reduce operating and production costs. To measure productivity, equipment utilization benchmarks can be employed to measure and identify optimal, normal and suboptimal utilization of the equipment. In mining facilities, “on vehicle” sensors can be used to compute primitive metrics that can be evaluated against established benchmarks in order to measure efficiency. Examples of computed metrics include, but are not limited to, a number of shovel dumps per shift, and an average weight of load in haul truck per shift.

The description above is presented as a general overview of related art in this field and should not be construed as an admission that any of the information it contains constitutes prior art against the present patent application.

### SUMMARY

There is provided, in accordance with an embodiment of the present invention a method, including receiving, by a computer, signals from a multiplicity of independently operated mobile entities, identifying, based on the received signals, a collaboration between a first given entity and a second given entity, and computing, based on the received signals, a quality of the collaboration.

There is also provided, in accordance with an embodiment of the present invention a system, including a memory, and a processor configured to receive signals from a multiplicity of independently operated mobile entities, to store sensor data indicated by the received signals to the memory, to identify, based on the sensor data, a collaboration between a first given entity and a second given entity, and to compute, based on the received signals, a quality of the collaboration.

There is further provided, in accordance with an embodiment of the present invention a computer program product, the computer program product including a non-transitory computer readable storage medium having computer readable program code embodied therewith, the computer readable program code including computer readable program code configured to receive signals from a multiplicity of independently operated mobile entities, computer readable program code configured to identify, based on the received signals, a collaboration between a first given entity and a second given entity, and computer readable program code configured to compute, based on the received signals, a quality of the collaboration.

### BRIEF DESCRIPTION OF THE DRAWINGS

The disclosure is herein described, by way of example only, with reference to the accompanying drawings, wherein:

FIG. 1 is a schematic pictorial illustration of a mining facility configured to compute behavioral group performance characteristics, in accordance with an embodiment of the present invention; and

FIG. 2 is a flow diagram that schematically illustrates a method of computing behavioral group performance characteristics, in accordance an embodiment of the present invention.

### DETAILED DESCRIPTION OF EMBODIMENTS

### Overview

In addition to standalone tasks that can be measured using individual benchmarks, some tasks are collaborative in nature and therefore involve more than one entity. In a collaborative task, each entity involved in the task can impact the overall performance of the task. Therefore, when analyzing productivity of a collaborative task, benchmarking a single entity can fail to explain any reasons for losses of productivity and inefficiencies.

For example, a collaborative task in a mining facility may comprise a driver of a haul truck positioning the truck quickly and accurately to enable an operator of a shovel loader to dump material into the haul truck. If the driver of the haul truck does not position the haul truck correctly, the shovel loader may not be able to dump all the material into the haul truck. Likewise, if the shovel loader loads too much material into the haul truck, the haul truck may need to jettison some of the material in order to able to transport the material.

Embodiments of the present invention provide methods and systems for measuring productivity metrics of entities jointly performing a collaborative task. In embodiments of the present invention, entities are typically independently operated (i.e., each entity can be an individual or a device independently controlled by an individual) and mobile (i.e., each entity moves while performing the collaborative task). As explained hereinbelow, the metrics can be based on location analysis, movement analysis and task analysis, and can be used to determine how the individual performance of each entity (in this case shovel loaders and haul trucks) impacts the overall result of the collaborative task.

In some embodiments, analyzing locations and/or proximities of the shovel loaders and the haul trucks can be used to help understand a collaboration of the vehicles (i.e., the shovel loaders and the haul trucks). In the absence of location data, synchronized timestamps and sensor correlation can be used to understand collaborative nature of vehicles, as explained hereinbelow. Additionally, movement analysis can be used to understand causal dependency between vehicles (e.g. a first vehicle is waiting because a second vehicle is blocking it).

While embodiments herein describe methods and systems for measure collaboration in a mining environment, systems implementing embodiments of the present invention can be used to measure productivity of any type of collaborative task that is performed in a physical space that involves moving people and/or physical assets. Additionally, systems implementing embodiments of the present invention can be used to compute new types of metrics that are based on dependencies between the people and/or the assets performing the collaborative task.

### System Description

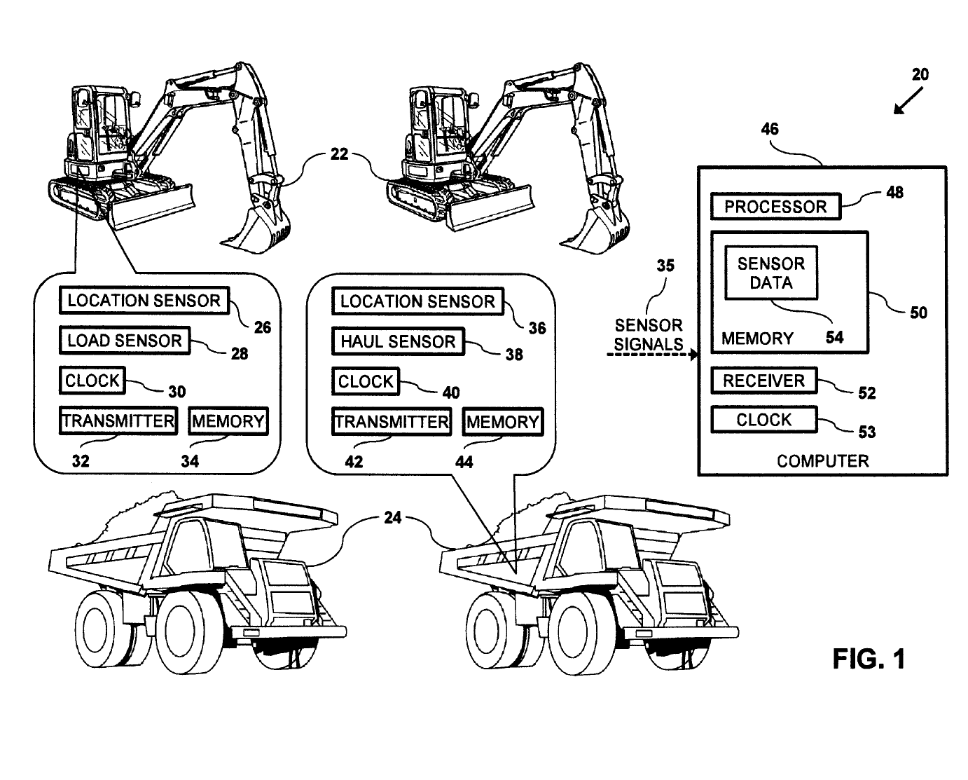

FIG. 1 is a schematic pictorial illustration of a mining site 20 (also referred to herein as a facility) configured to compute behavioral group performance characteristics of independently operated mobile entities operating in the mining facility, in accordance with an embodiment of the present invention. In the configuration shown in FIG. 1, the entities comprise shovel loaders 22 (also referred to herein as loaders 22) and haul trucks 24 (also referred to herein as haulers 24).

Each shovel loader 22 comprises a location sensor 26, a load sensor 28, a clock 30, a transmitter 32 and a memory 34. In some embodiments, location sensor 26 may comprise a global positioning system (GPS) sensor configured to provide real-time location information. In alternative embodiments, location sensor 26 may comprise a proximity sensor configured to identify any additional loaders 22 and/or haul trucks 24 in proximity to a given loader 22.

Load sensor 28 is configured to detect a weight of material in a given loader 22, thereby indicating when the given loader picks up and dumps the material. In some embodiments, sensors 26 and 28 can convey their respective readings to transmitter 32, which is configured to transmit sensor signals 35 indicating the sensor readings to a computer system 46. In alternative embodiments, sensors 26 and 28 can store their readings (including a corresponding timestamp from clock 30 for each of the readings) to memory 34.

Each haul truck 24 comprises a location sensor 36, a haul sensor 38, a clock 40, a transmitter 42 and a memory 44. In some embodiments, location sensor 36 may comprise a global positioning system (GPS) sensor configured to provide real-time location information. In alternative embodiments, location sensor 36 may comprise a proximity sensor configured to identify any additional loaders 22 and/or haulers 24 in proximity to a given hauler 24.

Haul sensor 38 is configured to detect a weight of material being carried by a given hauler 24. In some embodiments, sensors 36 and 38 can convey their respective readings to transmitter 42, which is configured to transmit sensor signals indicating the sensor readings to computer 46. In alternative embodiments, sensors 36 and 38 can store their readings (including a corresponding timestamp from clock 40 for each of the readings) to memory 44.

Computer 46 comprises a processor 48, a memory 50, a receiver 52, and a clock 53. In a first embodiment, receiver 52 can receive sensor signals 35 from transmitters 32 and 42, and store the sensor readings (indicated by the signals) and corresponding timestamps from clock 53 to sensor data 54 in memory 50. In alternative embodiments, the sensor readings and corresponding timestamps (from clocks 30 and 40) can be transferred to sensor data 54 by coupling memories 34 and 44 to memory 50, and then transferring the data.

Processor 48 typically comprises a general-purpose computer, which is programmed in software to carry out the functions described herein. The software may be downloaded to computer 46 in electronic form, over a network, for example, or it may be provided on non-transitory tangible media, such as optical, magnetic or electronic memory media. Alternatively, some or all of the functions of processor 48 may be carried out by dedicated or programmable digital hardware components, or using a combination of hardware and software elements.

While the example in FIG. 1 shows mining site 20, embodiments described herein can be used to compute behavioral group performance characteristics for other collaborative tasks that involve human decision making. For example, using radio-frequency identification (RFID) tags, computer 46 can be configured to monitor collaborative tasks performed by health-care professionals in a medical facility, or security personnel on a campus.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Productivity Metrics Computation

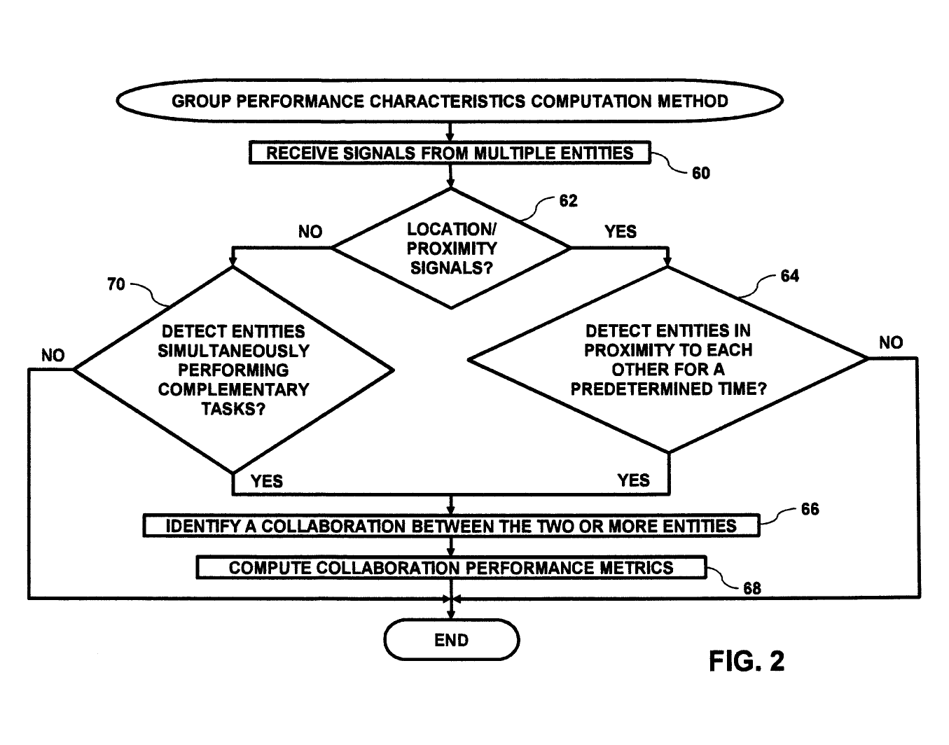

FIG. 2 is a flow diagram that schematically illustrates a method of computing behavioral group performance characteristics, in accordance an embodiment of the present invention. In a receive step 60, processor 48 receives signals from loaders 22 and haulers 24, and stores sensor data 54 indicated by the signals to memory 50. As described supra, processor 48 can receive the sensor data via receiver 52, or via a direct transfer from memories 34 and 44.

In a comparison step 62, if processor 48 receives location and/or proximity signals from sensors 26 and 36, then in a second comparison step 64, the processor determines if multiple entities are in proximity to each other for at least a predetermined time period. In other words, processor 48 can determine a location of each loader 22 and hauler 24 based on location (i.e., GPS) or proximity signals received from sensors 26 and 36.

In embodiments where sensors 26 and 36 comprise GPS sensors, processor 48 can analyze location data indicated by the signals to determine whether or not a given loader 22 and a given hauler 24 are in proximity to each other. In embodiments where sensors 26 and 36 comprise proximity sensors, processor 48 can analyze proximity data received from the proximity sensors to determine whether or not a given loader 22 and a given hauler 24 are in proximity to each other.

If a given loader 22 and a given hauler 24 are in proximity to each other for at least a predetermined time period, then processor 48 identifies a collaboration between the given loader and the given hauler in an identification step 66. To identify the collaboration, processor 48 can enrich the collected data with additional information such as user defined zones and traffic data, and incorporate the additional information into a model to help identify collaboration between a given loader 22 and a given hauler 24.

Finally, in a computation step 68, processor 48 computes collaboration performance metrics indicating a quality of the collaboration, and the method ends. Returning to step 64, if a given loader 22 and a given hauler 24 are not in proximity to each other for at least a predetermined time, then the method ends.

Returning to step 62, if processor 48 does not receive signals from sensors 26 and 36, then in a third comparison step 70, the processor analyzes task data received from sensors 28 and 38 to determine whether or not a given loader 22 and a given hauler 24 are simultaneously performing a complementary task. An example of task data indicating that a given loader 22 and a given hauler 24 are simultaneously performing a complementary task comprises load sensor 28 conveying a signal indicating a reduction in weight of material carried by the given loader and haul sensor 38 in the given hauler simultaneously indicating a simultaneous increase in weight of material carried by the given hauler.

If processor 48 detects that a given loader 22 and a given hauler 24 are simultaneously performing a complementary task, then the method continues with step 68. However, in comparison step 66, if processor 48 does not detect that a given loader 22 and a given hauler 24 are simultaneously performing a complementary task, then the method ends.

The collaboration performance metrics computed in step 70 can help identify a quality of collaboration between a given loader 22 and a given hauler 24 by analyzing respective performance levels of the vehicles. The quality of the collaboration may provide information such as levels of productivity, safety and efficiency of the collaboration, and examples of such collaboration are provided below.

In a first example, an analysis of the signals received in step 60 may indicate that a given loader 22 was idle for an extended period of time due to a given hauler 24 not arriving on time to a work area in mining site 20. However, by incorporating additional data into the collaboration analysis, processor 48 may determine that operator of the given hauler was not at fault for the given hauler not arriving on time. For example the given hauler may have been blocked by another vehicle, or there may have been too many haulers 24 at the mining site.

In a second example, a given loader 22 may spill some of the material when dumping the material into a given hauler, thereby wasting time and possibly causing the given hauler to leave with a less that optimal load. In a third example, a given loader 22 may dump too much material into a given hauler 24, thereby requiring the given hauler to dump some material before it can transport the material from the site.

To identify that a given loader 22 and a given hauler 24 are collaborating, processor 48 can compute metrics such as a total number of shovel dumps, a total time to load truck, and a total idle time of the shovel while loading. The following are steps processor 48 can use to compute the metrics:
1. Using signals received from sensors 26, 28, 36, 38, and clocks 30 and 40, processor 48 can first model a basic measurement M that comprises information such as an entity identifier (ID), a sensor ID, a timestamp, a metric type, and a measurement value.
2. Processor 48 then can then define a spatial enriched measurement M* comprising a data record which contains the location data (when available) at the given point in time of the measured metrics. For example, when using GPS signals, the collaboration location data may comprise enclosing, within a polygon or a circle, all GPS points received during the collaboration. Alternatively, the location data may comprise a center of the cluster (point) of the received GPS location points. When timestamps do not match exactly, the location can be interpolated to estimate a location at the measured point in time. The resulting record can include information such as an entity ID, a sensor ID, a timestamp, a metric type, a measurement value, and a location.
3. Processor 48 can then define a collaboration analysis CA as a process which determines that two or more entities are collaborating for a given period of time. The most basic analysis typically determines that entities are collaborating based on proximity. In some embodiments, the location field in M* can be used to identify entities in proximity to each other. In an alternative embodiment using advanced proximity analysis, processor 48 can analyze sequence patterns of specific sensors that indicate measurements such as respective weights of a given loader and a given hauler 24, and identify a collaboration based on timestamps from their respective clocks 30 and 40. Classical event processing and/or database queries can be applied here to define and detect these patterns as a combination of sequence events and conditions (on the weight measurements).
4. In an analysis step, processor 48 can produce a collaboration span C which defines a time span in which two or more entities are collaborating. The result of the analysis step can include information such as an analysis ID, a collaboration type, a start timestamp, an end timestamp, and identifiers of the entities (i.e., multiple loaders 22 and/or haulers 24) that are collaborating.
5. Finally, processor 48 can define a new metric over the domain and records of M* and C.

The flowchart(s) and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method, comprising:
receiving, by a computer, signals from a multiplicity of independently operated mobile entities;
identifying, based on the received signals, a collaboration between a first given entity and a second given entity; and
computing, based on the received signals, a quality of the collaboration.

2. The method according to claim 1, wherein the signals from each of the entities comprise location data and corresponding timestamps.

3. The method according to claim 2, wherein identifying the collaboration comprises detecting, based on the location data and the timestamps, the first and the second given entities in proximity to each other for at least a predetermined time period.

4. The method according to claim 2, wherein the location data is selected from a list consisting of global positioning sensor data and proximity data.

5. The method according to claim 1, wherein the signals comprise timestamps and task data.

6. The method according to claim 5, wherein identifying the collaboration comprises detecting, based on the timestamps and the task data, the first and the second given entities simultaneously performing a complementary task.

7. The method according to claim 1, wherein determining the quality of the collaboration comprises analyzing respective performance levels for the first and the second given entities.

8. A system, comprising:
a memory; and
a processor configured to receive signals from a multiplicity of independently operated mobile entities, to store sensor data indicated by the received signals to the memory, to identify, based on the sensor data, a collaboration between a first given entity and a second given entity, and to compute, based on the received signals, a quality of the collaboration.

9. The system according to claim 8, wherein the signals from each of the entities comprise location data and corresponding timestamps.

10. The system according to claim 9, wherein the computer is configured to identify the collaboration by detecting, based on the location data and the timestamps, the first and the second given entities in proximity to each other for at least a predetermined time period.

11. The system according to claim 9, wherein the location data is selected from a list consisting of global positioning sensor data and proximity data.

12. The system according to claim 8, wherein the signals comprise timestamps and task data.

13. The system according to claim 12, wherein the computer is configured to identify the collaboration by detecting, based on the timestamps and the task data, the first and the second given entities simultaneously performing a complementary task.

14. The system according to claim 8, wherein the computer is configured to determine the quality of the collaboration by analyzing respective performance levels for the first and the second given entities.

15. A computer program product, the computer program product comprising:
a non-transitory computer readable storage medium having computer readable program code embodied therewith, the computer readable program code comprising:
computer readable program code configured to receive signals from a multiplicity of independently operated mobile entities;
computer readable program code configured to identify, based on the received signals, a collaboration between a first given entity and a second given entity; and
computer readable program code configured to compute, based on the received signals, a quality of the collaboration.

16. The computer program product according to claim 15, wherein the signals from each of the entities comprise location data and corresponding timestamps.

17. The computer program product according to claim 16, wherein the computer readable program code is configured to identify the collaboration by detecting, based on the location data and the timestamps, the first and the second given entities in proximity to each other for at least a predetermined time period.

18. The computer program product according to claim 16, wherein the location data is selected from a list consisting of global positioning sensor data and proximity data.

19. The computer program product according to claim 15, wherein the signals comprise timestamps and task data.

20. The computer program product according to claim 19, wherein the computer readable program code is configured identify the collaboration by detecting, based on the timestamps and the task data, the first and the second given entities simultaneously performing a complementary task.
